(19) United States
(12) Patent Application Publication
(10) Pub. No.: US 2010/0119938 A1
(43) Pub. Date: May 13, 2010

(54) BATTERY SEPARATOR

(76) Inventors: Boaz Nitzan, Sde-Warburg (IL); Shlomo Levy, Rehovot (IL)

Correspondence Address: KENYON & KENYON LLP, 1500 K STREET N.W., SUITE 700, WASHINGTON, DC, 20005, US

(21) Appl. No.: 12/519,711

(22) PCT Filed: Dec. 18, 2007
(86) PCT No.: PCT/IL07/01562

§ 371 Date: Jun. 17, 2009

Related U.S. Application Data
(60) Provisional application No. 60/870,428, filed on Dec. 18, 2006.

(51) Int. Cl. H01M 6/14; H01M 2/16

(52) U.S. Cl. 429/199; 429/254; 427/58

(57) ABSTRACT

The present invention is of a battery separator comprising a reaction product of a polymer and a polyvalent metal. The present invention further provides a method of forming a battery separator comprising applying a polymer such as an acrylic polymer such that it reacts with a polyvalent metal in a battery component layer to form a separator. In some embodiments applying is by a printing technique. Further, the present invention is of a battery including a separator of the present invention and a method of making same.

### FIELD OF THE INVENTION

The present invention is of a battery separator. Moreover, the present invention is of a printable battery separator and use thereof in a printed battery.

### BACKGROUND OF THE INVENTION

There is known in the art thin and flexible batteries, which can be made using printing techniques. Thin and flexible batteries require a means of separation, such as a separator to separate the two battery poles in order to prevent a short circuit. One example of a separator for thin and flexible batteries is a filter paper which can be applied between the poles of the battery. However, in a method of mass production such as a roll to roll printing production of a cell, the step of applying a separator is inaccurate and slow resulting in a more expensive battery. It would be advantageous to have an improved method to overcome these problems, such as by printing the separator. However, the technique of printing uses liquid inks and as a separator is usually solid or semi-solid, printing of such a separator element is problematic.

It would therefore be desirable to have a method of forming a separator which is facile, spontaneous and cheap. Further, it would be desirable to have a method of printing a separator which could be incorporated in mass production of a battery. The present invention provides such a separator and battery including same.

### BRIEF DESCRIPTION OF THE DRAWINGS

With reference now to the drawings in detail, it is stressed that the particulars shown, are by way of example and for the purposes of illustrative discussion of the preferred embodiment of the present invention only, and are presented for providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1a shows a schematic view of a battery including a separator according to one embodiment of the present invention;

FIG. 1b shows a schematic view of a battery including a separator according to one embodiment of the present invention;

FIG. 1c shows a schematic view of a battery in a coplanar orientation including a separator according to one embodiment of the present invention;

FIG. 1d shows a schematic view of a battery in a coplanar orientation including a separator according to one embodiment of the present invention;

FIG. 2 shows a flow chart of a method of making a printed separator according to one embodiment of the present invention;

FIG. 3 shows a flow chart of a method of making a separator according to one embodiment of the present invention;

FIG. 4 shows a flow chart of a method of forming a separator according to one embodiment of the present invention;

FIG. 5 shows a flow chart of a method of making a battery including a separator according to one embodiment of the present invention;

FIG. 6 shows a flow chart of a method of making a battery including a separator according to one embodiment of the present invention;

FIG. 7 shows a flow chart of a method of making a battery including a separator according to one embodiment of the present invention;

FIG. 8 shows a flow chart of a method of making a coplanar battery including a separator according to one embodiment of the present invention;

FIG. 9 shows a flow chart of a method of making a coplanar battery including a separator according to an embodiment of the present invention; and

FIG. 10 shows a graph comparing the capacity over time for a battery with a printed separator according to an embodiment of the present invention and a battery with a paper separator.

### DETAILED DESCRIPTION OF THE PREFERRED EMBODIMENTS

The present invention is of a battery separator and method of production thereof. Further, the present invention is of a battery including a printed battery separator and method of production thereof.

In one embodiment, the present invention provides a battery separator comprising a reaction product of a layer of non-electrolyte polymer comprising an ionic, cross-linking functional group and a polyvalent metal ion.

In a further embodiment, the present invention provides a method of forming a battery separator in situ comprising applying a non-electrolyte layer comprising a polymer such that the polymer reacts with a polyvalent metal ion to form a separator comprising a polymer metal ion product and wherein the polyvalent metal ion is part of a battery component layer.

In an additional embodiment, the present invention provides a battery comprising at least one layer of a first pole material; at least one layer of a second pole material of opposite polarity from the first pole material; at least one layer of electrolyte disposed between the first pole material and the second pole material; and at least one separator wherein the separator is formed in situ directly on or near the first pole material, such that the separator is non-equidistant between the first pole and second pole.

In another embodiment, the present invention provides a battery comprising a first pole material; a second pole material of opposite polarity from the first pole material; wherein the first pole material and the second pole material are coplanar in spaced relation to each other; an electrolyte in contact with the first pole and the second pole; and a separator covering or partially covering the first pole material, but not substantially covering or partially covering the second pole material.

In a still further embodiment, the present invention provides a method of making a thin and flexible battery comprising: applying a layer of a first pole material onto a first substrate; applying at least one layer of electrolyte onto the layer of the first pole; applying a layer of a second pole material onto a second substrate; and either (a) applying a non-electrolyte layer of a separator forming polymer onto the layer of second pole wherein the second pole comprises a polyvalent metal which reacts with the separator forming polymer to form a separator layer comprising a reaction product of the polyvalent metal and the polymer; or (b) (i) applying a layer of electrolyte onto the layer of the second pole; wherein at least one of the layers of electrolyte comprises a polyvalent metal which reacts with a non-electrolyte separator forming polymer to form a separator; and (ii) applying a layer of non-electrolyte separator forming polymer onto one of the layers of electrolyte to form a separator layer comprising a reaction product of the polyvalent metal and the polymer; and contacting and laminating the first substrate to the second substrate, such that the layer of separator is disposed between the first pole layer and second pole layer.

In an alternative embodiment, the present invention provides a method of forming a battery comprising: applying a first pole material onto a base layer substrate; applying a separator on the first pole material; applying a second pole material of opposite polarity from the first pole material on the base layer substrate in the same plane and in spaced relation to the first pole material after applying of the separator on the first pole material; and applying an electrolyte; wherein the separator does not cover or partially cover the second pole material.

The principles and operation of a separator and battery including same, according to the present invention may be better understood with reference to the figures. The figures show non-limiting embodiments of the present invention.

### The Separator

In one embodiment the present invention provides a battery separator, which may include a polymer product, such as but not limited to a complex of a suitable polymer and a polyvalent metal, which may be referred to as a polymer reaction product or a polymer metal ion product. In some embodiments, the suitable polymer is a non-electrolyte polymer, such that the polymer or composition or layer including the polymer, before reaction with the polyvalent metal, would not be considered an electrolyte by one skilled in the art. In some embodiments the polymer reaction product is of at least one separator forming polymer anion or salt and at least one polyvalent metal cation. In one non-limiting example the reaction product is of at least one acrylic polymer anion or salt and at least one transition metal cation. In an alternative embodiment, the present invention provides a polymer reaction product of at least one separator forming cation and at least one polyvalent metal anion. In such an embodiment a suitable polyvalent metal anion is one which forms a polymer product, which is insoluble in the battery electrolyte and which is a cross-linking polyvalent metal anion. The charged polymer functional group may be a pendant group or a terminal group.

As used herein the term ‘separator’ includes, but is not limited to a means or element for preventing physical and/or electrical contact between the poles of a battery. The separator may be porous to facilitate movement of ions and may be non electrically conducting. In some batteries the separator may be porous to facilitate movement of water.

As used herein the terms ‘polymer’ or ‘suitable polymer’ or ‘separator forming polymer’ may be used interchangeably and include, but are not limited to any suitable polymer which is charged or includes a charged substituent and which is stable when contacted with the electrolyte of the battery. Typically, the charge is negative. Optionally, the polymer may be positively charged. The terms include a polymer in any suitable form, such as in solution, emulsion or dispersion. The terms further include a polymer, which is chemically associated/bonded/complexed with a stabilizing agent and wherein the polymer may be uncharged, but the stabilizing agent is charged

Non-limiting examples of a suitable separator forming polymer include an acrylic polymer or a vinyl polymer. Further examples include urethanes and acrylamides. Non-limiting examples of suitable acrylic polymers include, but are not limited to, Joncryl 661 and Joncryl FLX 5000. Non-limiting examples of vinyl polymers include polymers of the esters of vinyl alcohol, such as vinyl formate, vinyl propionate, vinyl acetate and vinyl butyrate. In some embodiments the polymer comprises at least one cross-linking functional group, wherein the at least one cross-linking functional group may be in an ionized state. In some embodiments, the polymer may be water compatible and/or water soluble and may be a water based emulsion. The polymer may be an acid functional polymer.

The separator forming polymer may be in an acidic or basic environment to facilitate ionization of the functional groups and anion formation. Optionally, the environment may be neutral. The separator forming polymer may be part of a mixture such as for example an ink which may further comprise at least one additive. Non limiting examples of additives include an antifoaming agent, a surfactant, a drying enhancer, a viscosifier, a rheological agent, a leveling agent, a coalescent agent, a wetting agent, a plasticizer, a solvent and combinations thereof. Any suitable antifoaming agent, surfactant, drying enhancer, viscosifier, rheological agent, leveling agent, coalescent agent, wetting agent, plasticizer, and solvent as known in the art may be used. Typically, additives are chemically compatible with the polymer. A non-limiting example of a suitable drying enhancer is an organic solvent, such as propylene glycol or a suitable alkanol derivative. A non-limiting example of a suitable wetting agent is a diol.

The polyvalent metal may be any suitable positively charged metal with a valency of at least two, for example a transition metal. Non-limiting examples include zinc, manganese, titanium, aluminum, chromium, iron, nickel copper, palladium, silver, platinum, gold, tin, zirconium, mercury and tungsten and combinations thereof. The polyvalent metal may be in the form of at least one of a halide, oxide, hydroxide, carbonate or acetate. Typically, the polyvalent metal used is one which does not adversely interfere with the electrical properties of the cell. The polyvalent metal may be included in or part of at least one battery component. Suitable battery components include the electrolyte layer, the positive pole, the negative pole and a combination thereof. In one non-limiting example the polyvalent metal which reacts to form part of the separator is a zinc ion, which is formed from the material of a zinc pole of the battery. In an alternative embodiment, the polyvalent metal which forms part of the separator is a zinc ion from zinc chloride of the electrolyte. In a further embodiment, the separator polyvalent metal may be a mixture of zinc ions from the pole and from the electrolyte.

In a less preferred embodiment, the separator of the present invention may include a monovalent metal. The resulting separator is non-optimal as a monovalent metal may not form a network.

The separator of the present invention may be in any suitable form, such as but not limited to a film or a gel or a semi-solid or precipitate or combination thereof. The separator may be of any suitable thickness. In some embodiment the thickness is from about 1 micron to about 100 microns however thinner and thicker separators are possible. The thickness of the separator may be related to the amount of separator forming polymer and the printing parameters.

Typically, the formed separator is porous and may be of any suitable porosity. In some embodiments the size of the pores of the formed separator is greater than about 10 microns. In one embodiment, the size of the pores of the separator is from about 20 microns to about 50 microns. The amount, size and shape of the pores differ depending on the drying technique used. As such, the crystal structure of the formed separator with each drying technique may be different.

The present invention provides a separator which may be porous, flexible and uniform and which may cover the electrode area with high precision and uniformity to prevent shorts. In some embodiments the uniformity and characteristics of the separator film may be controlled by the time/speed of the reaction between the separator forming polymer and polyvalent metal, such as by the use of drying techniques and control of temperature and by the use and control of amount of additives. In some embodiments the separator may include additives, which are used in order to facilitate a desired degree of flexibility. The strength of the formed separator may be determined according to the backbone separator forming polymer, additives and solvents used.

### Structure of a Battery Comprising a Separator of the Present Invention

In one embodiment the present invention provides a battery including a separator as described herein above and below. In some embodiments the battery may be a thin and flexible battery. As used herein the term ‘battery’ includes, but is not limited to any suitable device which may store energy and which may provide the energy in electrical form. The term includes a device which converts chemical energy into electrical energy and which may produce an electric current when connected in a circuit. A battery may include at least one or a plurality of electrochemical cell/s including galvanic cells, electrolytic cells and fuel cells.

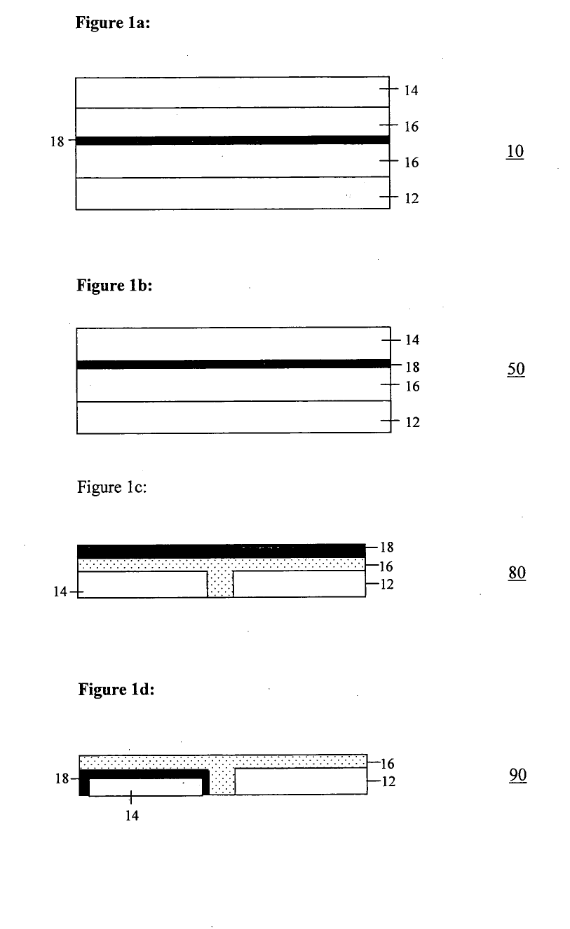

FIG. 1a shows a schematic view of a battery including a separator according to one embodiment of the present invention. The battery 10 may be any suitable battery of any size or shape. In the embodiment shown in FIG. 1a, the battery 10 is a thin and flexible battery, which may be open or closed. The battery may include at least one positive pole 12, at least one negative pole 14 (opposite polarity to pole 12), an electrolyte 16 and a separator 18. The battery 10 may include water, a separator forming polymer anion and a polyvalent metal cation.

The positive pole 12 may feature a layer of any suitable insoluble electro-active pole substance as known in the art. In some embodiments, the positive pole material may include a polyvalent metal, such as a transition metal, which may form or comprise a transition metal ion. Non limiting examples include manganese dioxide, silver oxide, nickel oxide, lead oxide, copper oxide, and mercury oxide. The positive pole 12 may further include any suitable additive, such as a binder and solvent as known in the art. In some embodiments the polyvalent metal of the positive pole 12 may be unreactive with a separator forming polymer, such as an acrylic polymer or may be treated to facilitate unreactivity with a separator forming polymer.

The negative pole 14 may feature a layer of any suitable insoluble electro-active pole substance as known in the art. In some embodiments, the negative pole material may include a polyvalent metal, which may form or comprise a polyvalent metal ion. Non limiting examples include zinc, aluminum, magnesium, cadmium, iron, platinum, silver, graphite, copper and gold. The negative pole 14 may further include any suitable additives such as a binder and solvent as known in the art.

The electrolyte 16 may include one or a plurality of electrolyte layers and may include any suitable electrolyte components, such as an electro-active soluble material and other additives such as a deliquescent agent and viscosifiers. In some embodiments, the electrolyte may include a polyvalent metal, such as but not limited to a transition metal, which may form or comprise a polyvalent metal ion, such as a transition metal ion. Non-limiting examples of polyvalent metal components which may be included in the electrolyte of the present invention include zinc chloride, zinc fluoride, zinc bromide, nickel halide, titanium halide, vanadium halide, iron halide, polyvalent metal oxides, polyvalent metal hydroxides, polyvalent metal carbonates, polyvalent metal acetates and any suitable polyvalent metal salt. In one embodiment the electrolyte 16 includes zinc chloride.

The separator 18 may comprise a reaction product of a separator forming polymer such as but not limited to an acrylic polymer and a polyvalent metal, such as a transition metal as described hereinabove in the section entitled ‘Separator’. Typically, the separator formation is controlled to result in a separator with a permeability which facilitates optimal battery function. In the embodiment shown in FIG. 1a the separator 18 is disposed on one pole layer of electrolyte, such that it is disposed in electrolyte 16 and is equidistant from the two poles 12, 14.

FIG. 1b shows a battery according to one embodiment of the present invention 50, wherein the separator 18 is disposed on one of the poles. As described hereinabove, the separator 18 comprises a reaction product of a separator forming polymer and a polyvalent metal. In the embodiment of FIG. 1b, the separator 18 is disposed on pole 14. A battery 50 in which the separator 18 is disposed on the pole 14, may have properties of high internal resistance and low cell capacity. In some embodiments conditions are modified in order to prevent the formed separator 18 from completely sealing the pole 14 on which it is formed. In one non-limiting example very fast drying of the separator 18 may be used. In an embodiment, wherein the separator 18 is formed on one of the poles, the separator may not be equidistant between the two poles 12, 14. In an alternative embodiment, which is not shown in the figures the battery may include the separator 18 disposed on pole 12 instead of on pole 14.

In one embodiment (not shown in the figures), a battery may include a plurality of separators such that one separator 18 may be disposed on pole 12 and a second separator may be disposed on pole 14 or one separator may be disposed on one of the poles 12; 14 and a second separator may be disposed on the electrolyte.

In one embodiment (not shown in the figures), wherein pole 12 or pole 14 has been prewetted with a solution containing a polyvalent metal, and a separator forming polymer is disposed on or about the prewetted pole, the separator 18, which forms may be formed on the prewetted pole or close to the prewetted pole, such that the separator 18 may not be equidistant between the poles 12, 14.

FIG. 1c shows a battery according to an embodiment of the present invention 80 wherein the battery poles 12, 14 are in a coplanar, side by side orientation and the separator 18 is disposed on (shown in FIG. 1c) or on and between (not shown in FIG. 1c) both poles 12, 14. As described hereinabove for FIG. 1a, the separator 18 comprises a reaction product of a separator forming polymer and a polyvalent metal.

FIG. 1d shows a battery according to an embodiment of the present invention 90 wherein the battery poles 12, 14 are in a coplanar, side by side orientation and the separator 18 is disposed on one pole. In FIG. 1d, the separator is disposed on pole 14. The separator 18 may completely cover or partially cover the pole on which it is formed. In such a way the separator may be configured to mask or coat the pole. The separator may not substantially cover the other battery pole 12. The separator may be a separator formed by a printing or coating technique, by reaction of a polyvalent metal and a separator forming polymer as described hereinabove. In the embodiment shown in FIG. 1d, the separator 18 is not limited to the separator of the present invention described hereinabove, that is a product of a separator forming polymer and a polyvalent metal, but may be any suitable separator, which may or may not be printable, such as for example but not limited to filter paper. The present invention also includes an alternative embodiment wherein the separator 18 is formed on pole 12 and does not substantially cover the battery pole 14.

In some embodiments the properties of the battery may be determined and/or predetermined according to at least one of the following properties, the thickness of the separator, the porosity of the separator, the amount of separator forming polymer used, the characteristics of the separator forming polymer used, the polyvalent metal, and the location of the separator. In some embodiments the conductivity of a battery comprising a separator of the present invention is related to the separator porosity and separator thickness. In such a way it may be possible to design a battery with predetermined properties.

### Method of Forming a Battery Separator

The present invention provides a method of forming a battery separator. The method is based on the reaction between an anionic group of a separator forming polymer and a polyvalent metal cation. Transition metal salt cross-linking of acid containing emulsion polymers, which can be dried to a cross-linked film is known in the art. The inventors of the instant application discovered that this type of reaction could be modified to form a battery separator in situ, such that the separator may self-form, using for example a printing technique.

As described above the method may also include the reaction between a cationic group of a separator forming polymer and a polyvalent metal anionic group.

The two separator forming groups may react to form a product which precipitates. This reaction may be depicted as follows:

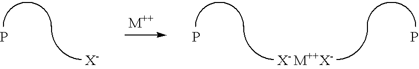

wherein P is a polymer;

X is the anionic group of the polymer; and

M is a polyvalent metal.

The reaction may be spontaneous and may be immediate. In some embodiments, the reaction may be controlled, such as but not limited to the rate of the reaction and extent of reaction. Non limiting examples of controlling parameters include modulating pH of the solution. The separator film performance may be affected by a drying procedure such as by use of heat, air heating or IR. The product of the reaction may precipitate and may function as a battery separator.

The method of forming a battery separator according to the present invention comprises applying a separator forming polymer such that the polymer and/or an ionized group of the separator forming polymer or polymer stabilizing agent may react with a polyvalent metal and or polyvalent metal ion, which is part of a battery component layer, to form a separator. Typically, the polymer includes a cross-linking functionality which can react with a polyvalent metal to form a product which may be configured as a separator. The polymer may be a self-cross-linking polymer. In some embodiments the polymer is applied onto the battery component which comprises the polyvalent metal. The polymer may be applied onto the electrode layer, which may be dry or wet or may be applied onto the electrolyte layer. In one embodiment applying is by any suitable printing or coating technique. In some embodiments the amount of polyvalent metal ion is in excess of the surface amount of polymer.

As used herein the term ‘printing’ includes, but is not limited to a method of application which facilitates applying and may facilitate reproducing a pattern on a surface by any of various techniques such as, but not limited to silk printing, offset printing, jet printing, laminations, material evaporations and powder dispersion and spray printing, vapor deposition, photo etching, embossing, diffusion and screen printing. Printing may employ any suitable form and/or formulation of a compound to be applied. The technique of printing an element may eliminate the need to use additional attachment or application means.

The present invention provides a method of forming a separator using application of layers of the reactive ingredients, such as a layer of separator forming polymer and a layer including a polyvalent metal. Such a method facilitates application of the layers using a printing technique and formation of a homogenous separator in a suitable position in the cell. If the separator forming polymer and polyvalent metal in the electrolyte were to be mixed and added together, the separator would precipitate out and would hinder or prevent printing. In, an embodiment wherein the separator forming polymer is added and mixed with a pole material which includes a polyvalent metal, there would be shorting of the battery. As such, the method and order of adding the components which form the separator and other components of the cell are important in order to achieve a method of printing a separator and a method of forming a working cell with a separator.

The method of the present invention provides a separator which may be uniform and which may cover the electrode area with high precision and uniformity to prevent shorts. The separator is porous facilitating good electrical properties such as, but not limited to OCV, CCV, internal resistance, impedance and cell capacity. The method may be performed manually or using an automated process, such as a roll to roll production line. The present invention provides a method of making a separator, wherein the separator may be printed with good or optimal registration and thickness.

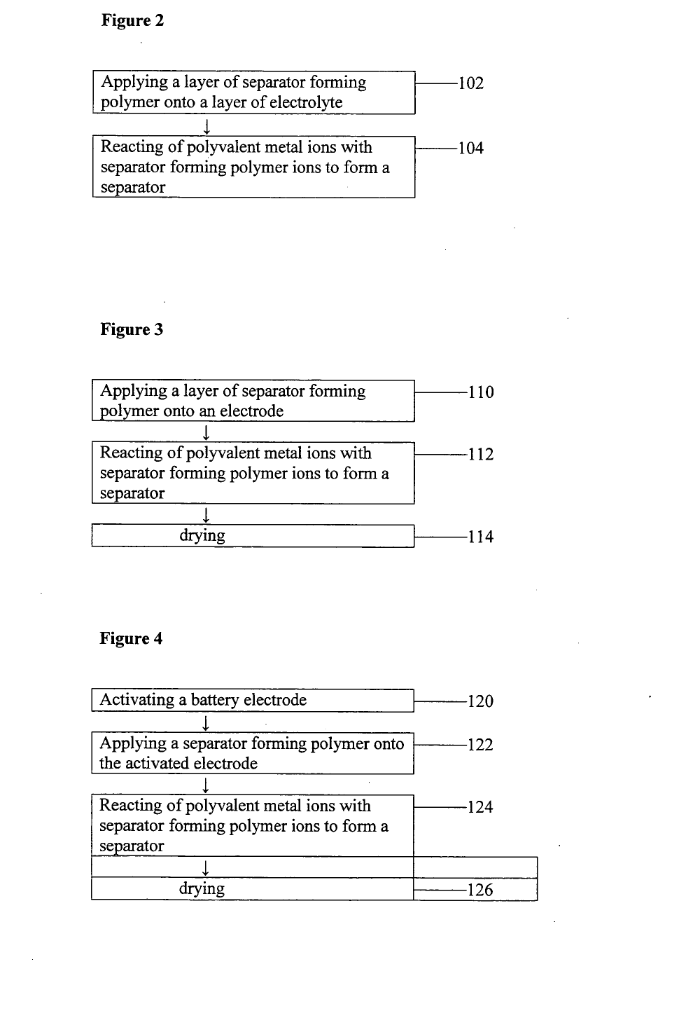

FIG. 2 shows a flow chart of a method of forming a battery separator according to one embodiment of the present invention. A layer of separator forming polymer, wherein the separator forming polymer may be as described hereinabove, may be applied onto a layer of electrolyte 102. The polymer may be an aqueous solution or emulsion of polymer facilitating ionization of functional groups of the polymer. In some embodiments, the layer of electrolyte may include at least one polyvalent metal ion as herein described. In one non-limiting example the electrolyte may include zinc chloride, which comprises zinc ions. The polyvalent metal ions may react with the anions of the applied separator forming polymer to form a precipitate 104. The precipitate may be of any suitable physical form which may facilitate separator function. In some embodiments, the separator is a film.

Applying may be done by any suitable method. Examples include dispensing, spraying, using a foam and printing and combinations thereof. The thickness of the applied separator forming polymer, such as acrylic polymer is important to the functioning of the separator and battery. In an embodiment, wherein the layer is too thick, the resistance of the cell will be very high. In an embodiment, wherein the layer is too thin, the resulting separator may include holes and/or may not sufficiently prevent contact between the negative pole and positive pole. In one embodiment the thickness of the formed separator is from about 10 microns to about 150 microns. In one embodiment, the separator thickness is from about 50 microns to about 90 microns. In one embodiment, the separator thickness is about 80 microns.

In an embodiment wherein printing is used, additives as described hereinabove may be added to the separator forming polymer to aid in the printing and to result in optimal separator formation. The additives may be added and mixed with the separator forming polymer to facilitate production of an ink.

FIG. 3 shows a flow chart of an alternative method of forming a battery separator according to one embodiment of the present invention. A layer of separator forming polymer as described hereinabove, may be applied onto a battery electrode 110. In some embodiments, the layer of electrode may include at least one polyvalent metal. In one non-limiting example the electrode may include zinc. The electrode may include polyvalent metal ions and/or the polyvalent metal ions may be formed from the polyvalent metal. In one non-limiting example reaction between water, which may be included in the separator forming polymer and the zinc electrode may promote formation of zinc ions.

The polyvalent metal ions may react with the anions of the applied separator forming polymer to form a precipitate 112. The precipitate may be any physical form which may facilitate separator function.

In order to avoid repetition applying may be done as outlined above for FIG. 2. It is noted that printing of a layer of wet separator forming polymer onto a layer of dry battery electrode is easier than the embodiment described in FIG. 2, wherein the wet separator forming polymer is printed onto the wet electrolyte.

In some embodiments, the separator may be dried 114 using any suitable drying technique. Non-limiting examples of drying techniques include IR, air oven and drying plates. The separator may be dried at a suitable temperature. In some embodiments, the temperature is above 100° C. Drying may facilitate better electrical performance and faster handling time. Application of heat and drying may stop or interrupt the reaction of the separator forming polymer with the polyvalent metal ions, from going to completion and forming a non-porous product. It is desirable that the separator product is partially cross-linked such that it forms with adequate pores.

FIG. 4 shows a flow chart of a further alternative method of forming a battery separator according to an embodiment of the present invention. A layer of battery electrode wherein the electrode may include a polyvalent metal may be activated, such as, but not limited to, by being wetted 120. The term ‘activated’ as used herein refers to promoting or catalyzing the formation of polyvalent metal ions on and/or in the battery electrode. The battery electrode may be wetted with electrolyte. The term ‘wetted’ as used herein refers to applying a solution containing a polyvalent metal, such as, but not limited to an electrolyte which may be a diluted liquid electrolyte. In one non-limiting example zinc chloride may be diluted with distilled water, such as in a ratio of about 1 to about 10. The diluted electrolyte may be applied to an extent that it is absorbed by the electrode material, but wherein visually the electrode may appear dry. The electrode may be dampened with the electrolyte. The wetting may be accomplished by for example using a stamp or a sponge or spraying and may be applied to the extent that the electrode layer would not be considered dry, but would be damp with electrolyte. In an alternative embodiment, the electrode ink may be mixed with a low percentage of polyvalent metal oxide, such as ZnO. The activation, such as wetting of the electrode may facilitate initiating of the electrode in order that the battery will function and the wetting may also facilitate formation of polyvalent metal ions. Wetting may also encourage reaction between the separator forming polymer and the polyvalent metal ions from the electrolyte, rather than reaction with the polyvalent metal of the battery electrode. Further, wetting may promote formation of pores.

A layer of separator forming polymer, wherein the polymer may be as described hereinabove may be applied onto the prior activated, such as wetted electrode 122. The polyvalent metal ions may react with the anions of the applied separator forming polymer to form a precipitate 124. The precipitate may be of any physical form which may facilitate separator function.

Applying may be done by any suitable method as described herein above for FIG. 2, such as by using a suitable printing technique.

In some embodiments of the method described in FIG. 4, the separator may be dried using any suitable drying technique 126. Non-limiting examples of drying techniques include IR, air oven and drying plates. Drying may facilitate better electrical performance and faster handling time.

Method of Forming a Battery which Includes a Separator of the Present Invention

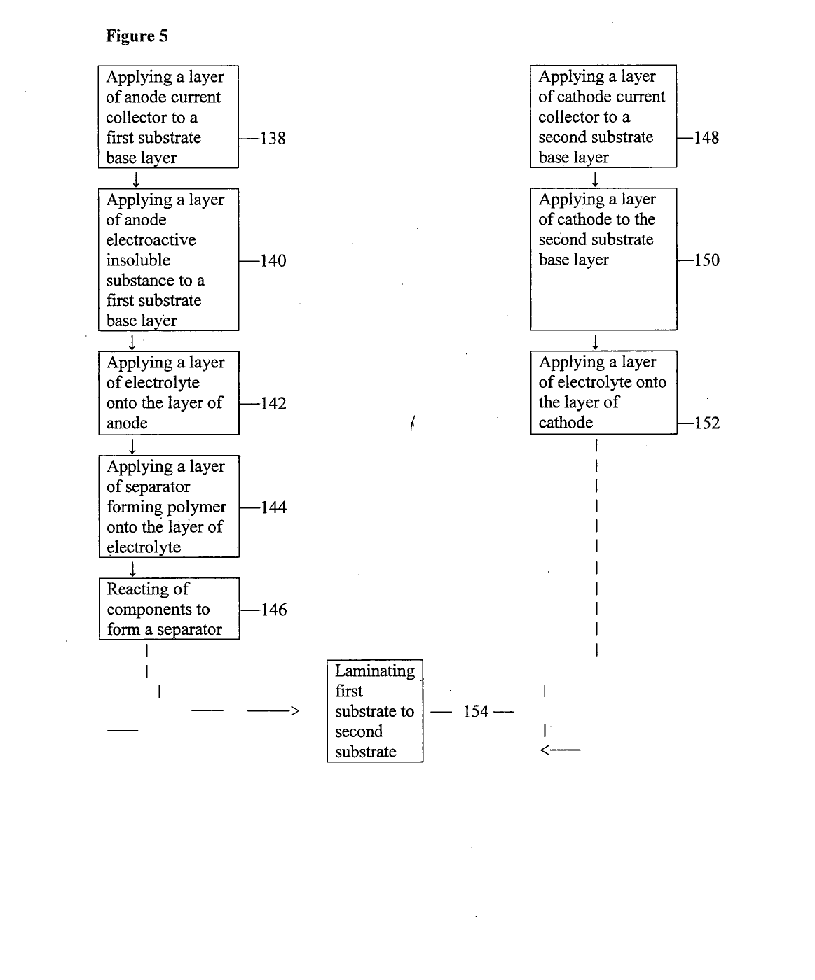

FIG. 5 shows a flow chart of a method of forming a battery according to an embodiment of the present invention. The battery may be made using printing technology. To a first base layer substrate may be applied a layer of anode electro-active insoluble substance 140. To the layer of anode electro-active insoluble substance may be applied a layer of electrolyte 142. The electrolyte is as herein described and may include a polyvalent metal ion. In one non-limiting embodiment, the electrolyte may include zinc ions. To the layer of electrolyte may be applied a layer of separator forming polymer, wherein the separator forming polymer is as herein described 144. The separator forming polymer may react with the polyvalent metal ions in the electrolyte to form a separator 146 as described in FIG. 2.

To a second base layer substrate may be applied a layer of cathode electro-active insoluble substance 150. To the layer of cathode electro-active insoluble substance may be added a layer of electrolyte 152.

The invention is not limited to the embodiment as described hereinabove for FIG. 5 wherein the separator is formed on the anode electrolyte, but instead or in addition it is envisioned that the electrolyte applied to the layer of cathode may include a polyvalent metal and to this electrolyte layer may be applied a separator forming polymer.

The first base layer substrate may be contacted and laminated with the second base layer substrate 154, to form a battery such that the anode and cathode are in a co-facial orientation with the separator disposed between the pole layers.

In some embodiments, the method may include applying a layer of anode current collector 138 and a layer of cathode current collector 148. In some embodiments the method may further comprise applying terminals. The method may further comprise applying lamination layers to protect the battery or to control how open or closed the battery is according to the application of use. The method may include further steps of sealing the cell.

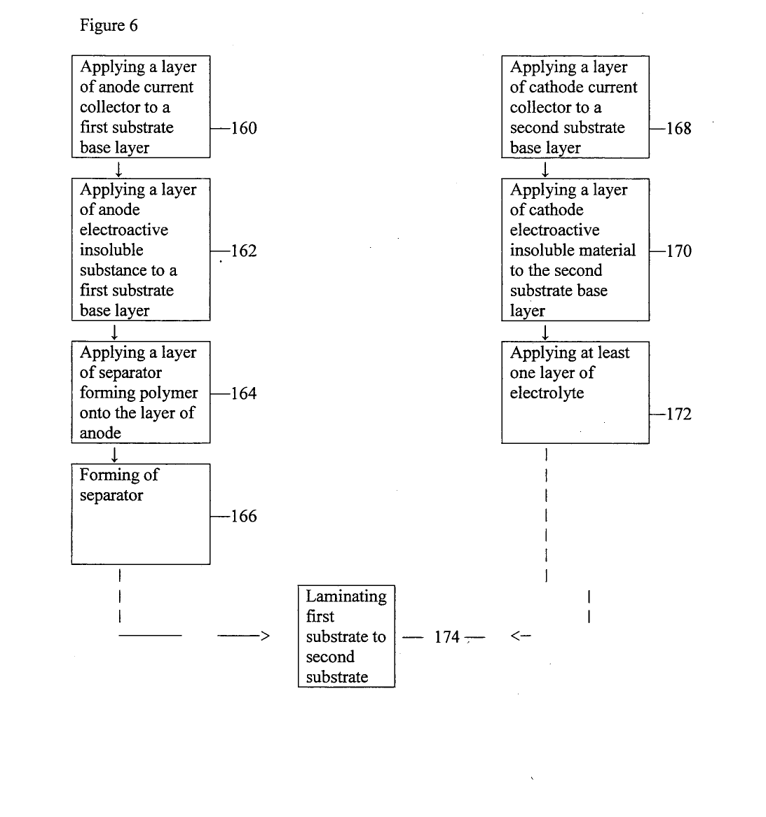

FIG. 6 shows a flow chart of a method of forming a battery according to an alternative embodiment of the present invention. To a first base layer substrate may be applied a layer of anode electro-active insoluble substance 162. To the layer of anode electro-active insoluble substance may be applied a layer of separator forming polymer 164, wherein the separator forming polymer is as herein described. The separator forming polymer may react with the polyvalent metal ions formed from the anode electro-active material to form a battery separator layer 166 as described in FIG. 3. The separator may be dried (not shown in the flow chart).

To a second base layer substrate may be applied a layer of cathode electro-active insoluble substance 170. To the layer of cathode electro-active insoluble substance may be added at least one layer of electrolyte 172. The at least one layer of electrolyte may be equivalent in amount and/or thickness to two layers of electrolyte. The thickness of the electrolyte layer may control properties of the formed battery, such as resistance.

The invention also includes an embodiment wherein the steps of the method are executed in order that a separator is formed on the cathode instead of on the anode.

The first base layer substrate may be contacted and laminated with the second base layer substrate, to form a battery 174 such that the anode and cathode are in a co-facial orientation with the separator disposed between the pole layers.

In some embodiments, the method may include applying a layer of anode current collector 160 and a layer of cathode current collector 168. In some embodiments the method may further comprise applying terminals. The method may further comprise applying lamination layers to protect the battery or to control how open or closed the battery is according to the application of use. The method may include further steps of sealing the cell.

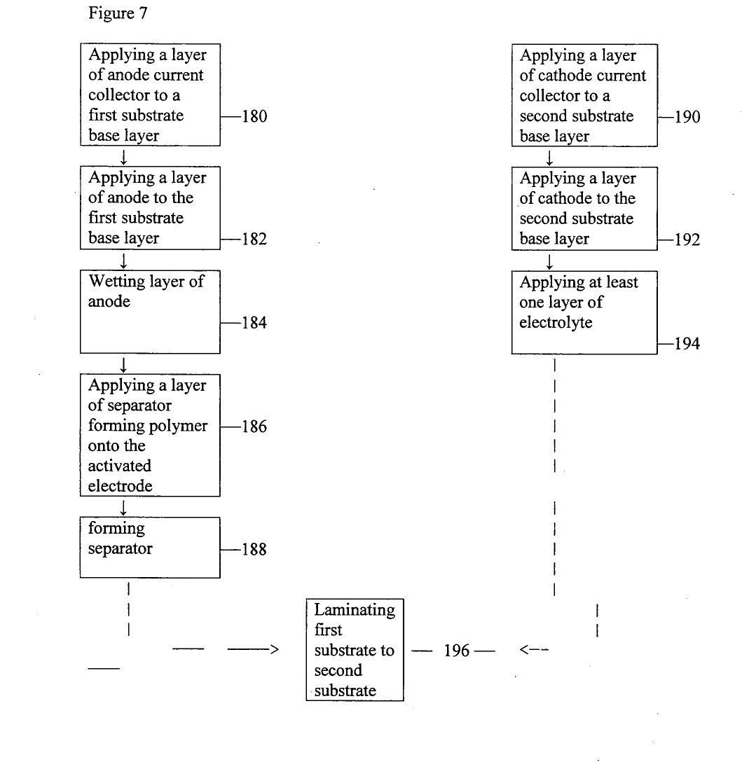

FIG. 7 shows a flow chart of a further method of forming a battery according to an embodiment of the present invention. To a first base layer substrate may be applied a layer of anode electro-active insoluble substance, which includes a polyvalent metal 182. The layer of anode electro-active insoluble substance may be activated 184 as described hereinabove in FIG. 4. The activating, such as, wetting of the anode may facilitate initiation of the electrode and formation of polyvalent metal ions. To the activated layer of anode electro-active insoluble substance may be applied a layer of separator forming polymer 186, wherein the polymer is as herein described. The separator forming polymer may react with the polyvalent metal ions formed from the anode electro-active material to form a battery separator layer 188 as described in FIG. 4. The separator may be dried (not shown in the flow chart).

To a second base layer substrate may be applied a layer of cathode electro-active insoluble substance 192. To the layer of cathode electro-active insoluble substance may be added at least one layer of electrolyte 194. The layer of electrolyte may be equivalent in amount and/or thickness to two layers of electrolyte.

The first base layer substrate may be contacted and laminated with the second base layer substrate, to form a battery 196 such that the anode and cathode are in a co-facial orientation with the separator disposed between the pole layers.

In some embodiments, the method may include applying a layer of anode current collector 180 and a layer of cathode current collector 190. In some embodiments the method may further comprise applying terminals. The method may further comprise applying lamination layers to protect the battery or to control how open or closed the battery is according to the application of use. The method may include further steps of sealing the cell.

FIG. 5, FIG. 6 and FIG. 7 describe use of two base layer substrates. The present invention also includes the same method detailed in those figures, but using only one base layer substrate. In an embodiment wherein only one base layer substrate is used, it may be necessary to incorporate ways of preventing cross contamination between the poles, such as by masking.

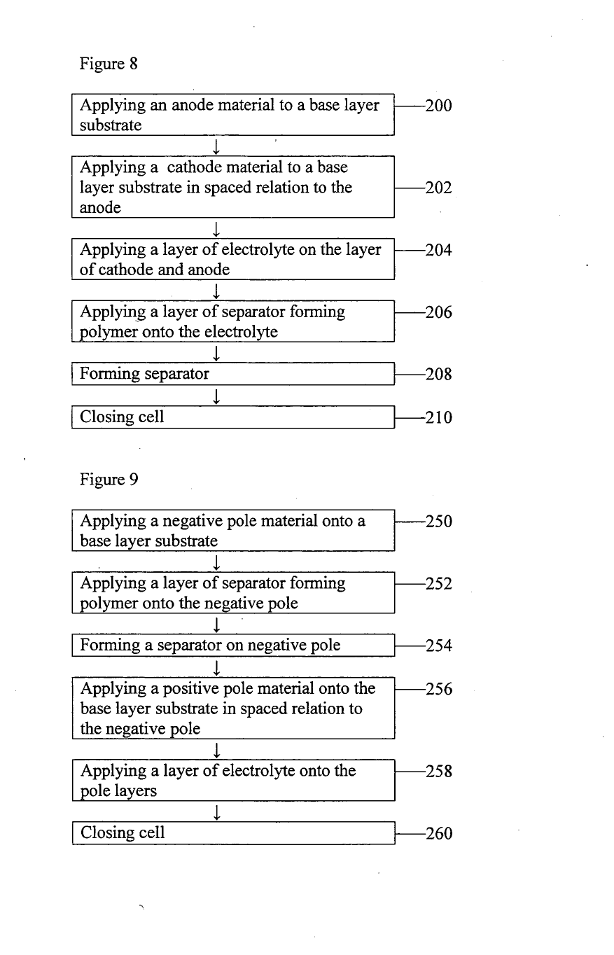

The present invention also provides a method of making a thin and flexible battery with a printed separator wherein the battery electrodes are in a coplanar orientation. FIG. 8 shows a flow chart of a method of forming a battery in a coplanar orientation according to an embodiment of the present invention. The battery may be made using a printing technology. To a base layer substrate may be applied a first pole substance, such as an anode electro-active insoluble substance 200 and a second pole substance, such as a cathode electro-active insoluble substance 202 in spaced relation to each other to define a gap between the two poles. To the layer of anode electro-active insoluble substance and cathode electro-active insoluble substance may be applied a layer of electrolyte, wherein the electrolyte includes a polyvalent metal 204 as hereinabove described. To the layer of electrolyte is applied a layer of a suitable separator forming polymer 206, wherein the polymer is as herein described. The separator forming polymer may react with the polyvalent metal from the electrolyte as hereinabove described to form a battery separator layer 208.

Any suitable method of closing of the cell may be employed 210. In one example the cell may be closed by folding of the base layer substrate or alternatively by applying a second base layer substrate which may be contacted and laminated with the first base layer substrate, to form a battery such that the anode and cathode are in a side by side orientation.

In some embodiments, the battery may include a layer of cathode current collector and a layer of anode current collector. The battery may further comprise terminals. The battery may further comprise lamination layers to protect the battery or to control how open or closed the battery is according to the application of use. The method may include further steps of sealing the cell.

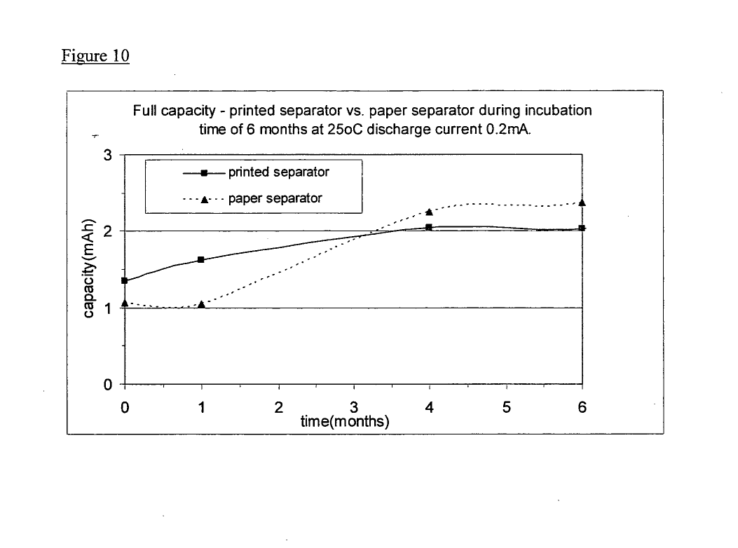

In an alternative embodiment of a method of making a thin and flexible battery with a separator wherein the battery electrodes are in a coplanar orientation, a separator may be formed on only one of the poles. FIG. 9 shows a flow chart of a method of forming a battery in a coplanar orientation according to such an embodiment of the present invention. To a base layer substrate may be applied a negative pole electro-active insoluble substance 250. In one non-limiting example the negative pole substance is zinc. To either the dry negative pole or to the negative pole which has been activated as described herein above, is applied by for example a printing technique a layer of separator forming polymer 252, wherein the polymer is as herein described. The polymer may react with the polyvalent metal of the dry or activated electrode as hereinabove described to form a separator layer 254. The separator layer may completely or partially cover the negative pole.

To the base layer substrate may then be applied a positive pole electro-active insoluble substance in spaced relation to the negative pole 256. A problem encountered when printing a battery in a coplanar configuration is cross contamination of the two pole materials. The present invention provides a solution to this type of contamination. The separator formed on the negative pole may function as a mask preventing contamination of the negative pole by the positive pole material. In this way it may also be possible to print a battery, for example a 3V battery, wherein a plurality of negative poles are applied using a printing technique, a suitable porous polymer is printed on each of the negative poles and after the separator has formed on each of the negative poles, a plurality of positive poles may be printed in the correct spaced relation to the negative poles.

A layer of electrolyte may be applied onto the pole layers 258. As described hereinabove in FIG. 8 any suitable method of closing of the cell may be employed 260. The battery may include current collectors and other battery components as known in the art or as described hereinabove.

In the description of FIG. 9, the separator is formed on the negative pole. The invention is not intended to be limited to formation of the separator on the negative pole. The invention also includes an embodiment wherein the separator is formed only on the positive pole.

Reference is now made to the following examples, which together with the above descriptions illustrate the invention in a non-limiting fashion.

### Example 1

### Preparation of a Separator Forming Polymer Ink Comprising an Ammonium Salt of a Modified Acrylic Copolymer

An ammonium salt of a modified acrylic copolymer, such as available from Bass Resins B.V. (about 70-85%) was mixed at room temperature with a low acid number resin solution, such as available from Bass Resins B.V. (about 5-25%), a wetting agent such as an organic solvent, an anti foaming agent and a coalescing agent, such as a suitable organic solvent to form a liquid ink.

### Example 2

### Preparation of a Separator Forming Polymer Ink

An acrylic emulsion in a range of from about 70 percent to about 85 percent was mixed with an acrylic resin in a range of from about 1 percent to about 10 percent at room temperature. To this mixture was added a suitable organic solvent in a range of from about 10 percent to about 20 percent and additives in a range of from about one percent to about 5 percent to form an ink.

### Example 3

### Preparation of a Battery Comprising a Separator Formed In Situ According to an Embodiment of the Present Invention

Two current collectors were printed onto two polyester substrates. The current collectors comprise a layer of current collector ink 2501, P/N 0002.25.01, produced by Power Paper Ltd. The current collectors were then oven dried. Zinc anode ink 2101, P/N 0002.21.01, produced by Power Paper Ltd was printed on top of one of the current collectors. Cathode manganese dioxide based ink 2201, P/N 0002.22.01, produced by Power Paper Ltd was printed on top of the second current collector.

Onto the layer of anode ink was printed the separator forming polymer ink prepared in Example 1. A porous separator formed in situ by reaction between zinc ions and the polymer anions. The layer was heated and dried.

Electrolyte ink 2301, P/N 0002.23.01, produced by Power Paper Ltd was printed onto the layer of cathode.

The battery was then assembled by laminating the anode substrate and the cathode substrate together.

### Example 4

### Comparison of the Capacity of a Battery with a Separator Formed According to an Embodiment of the Present Invention and a Paper Separator

A battery was prepared according to Example 3 and the capacity was compared with a similar battery, which included a paper separator. The batteries were incubated at room temperature and the capacity was measured at a discharge current of 0.2 mA over a storage period of 6 months. The graph of results is shown in FIG. 10. The graph shows that the battery with the printed separator exhibited comparable capacity to the battery with the paper separator.

### Example 5

### Preparation of a Battery Comprising a Separator Formed In Situ According to an Embodiment of the Present Invention, Wherein the Electrodes are in a Coplanar Configuration

Two current collectors were printed in spaced relation onto a polyester substrate. The current collectors comprised a layer of current collector ink 2501, P/N 0002.25.01, produced by Power Paper Ltd. The current collectors were then oven dried. Zinc anode ink 2101, P/N 0002.21.01, produced by Power Paper Ltd was printed on top of one of the current collectors. Onto the layer of anode ink was printed the separator forming polymer ink prepared in Example 1. A porous separator formed in situ on the anode by reaction between zinc ions and the polymer anions. The layer was heated and dried.

Cathode manganese dioxide based ink 2201, P/N 0002.22.01, produced by Power Paper Ltd was printed on top of the second current collector.

Electrolyte ink 2301, P/N 0002.23.01, produced by Power Paper Ltd was then printed onto the layer of masked anode and the cathode.

The battery was then sealed.

6 samples of the battery produced in example 5 were placed for 2 days in accelerated storage at 45° C. A capacity of 1.8 mAh/cm² was measured at a discharge current of 0.4 mA/cm2. The OCV was 3.04V.

It is to be understood that the invention is not limited in its application to the details of construction and the arrangement of the components set forth in the description. The invention includes other embodiments and can be practiced or implemented in various ways. Also it is to be understood that the phraseology and terminology employed herein is for the purpose of description only and should not be regarded as limiting.

1.-44. (canceled)

45. A battery porous separator comprising a reaction product of (a) a non-electrolyte layer of acrylic polymer, the acrylic polymer comprising at least one anionic, cross-linking functional group; and (b) a polyvalent metal ion derived from part of a battery component.

46. The battery separator of claim 45, wherein the battery component is at least one of an electrolyte layer and an electrode layer.

47. The battery separator of claim 45, wherein the separator is at least one of a film, semi-solid and precipitate.

48. The battery separator of claim 45, wherein the polymer is in solution and further comprises at least one additive.

49. The battery separator of claim 48, wherein the at least one additive is at least one of an antifoaming agent, a surfactant, a drying enhancer, a rheological agent, a leveling agent, a coalescent agent, a viscosifier, a wetting agent, a solvent and combinations thereof.

50. The battery separator of claim 45, wherein the separator is disposed on a battery electrode.

51. A method of forming a battery separator in situ comprising:
applying a non-electrolyte layer of an acrylic polymer comprising an anionic, cross-linking functional group onto a battery pole; and
reacting with a polyvalent transition metal ion disposed in a battery layer, to form a separator comprising the polymer metal ion product.

52. The method of claim 51, wherein the applying is by a printing or coating technique.

53. The method of claim 51, wherein the battery layer comprises an electrolyte layer or an electrode layer.

54. The method of claim 51, wherein the polymer is at least one of a polymer in solution or a polymer in dispersion.

55. The method of claim 51, wherein the polyvalent metal is zinc.

56. The method of claim 51, further comprising drying of the separator.

57. A battery comprising:
at least one layer of a first pole material;
at least one layer of a second pole material of opposite polarity from the first pole material;
at least one layer of electrolyte disposed between the first pole material and the second pole material; and
at least one separator of claim 45, wherein the separator is formed in situ on the first pole material.

58. The battery of claim 57, wherein the battery is thin and flexible.

59. The battery of claim 57 wherein at least one of the first pole material and the second pole material comprises zinc and the at least one layer of electrolyte comprises zinc chloride.

60. The battery of claim 57, wherein the at least one layer of first pole material and the at least one layer of second pole material are coplanar in spaced relation to each other; and the separator covers or partially covers the at least one layer of first pole material, but does not substantially cover or partially cover the at least one layer of second pole material.

61. The battery of claim 57, wherein the at least one layer of first pole material and the at least one layer of second pole material are cofacial to each other.
